(19) United States
(12) Patent Application Publication
(10) Pub. No.: US 2011/0158409 A1
(43) Pub. Date: Jun. 30, 2011

(54) WIRELESS COMMUNICATION APPARATUS, WIRELESS COMMUNICATION METHOD, AND WIRELESS COMMUNICATION PROGRAM

(75) Inventors: Norito Sugawara, Higashiyamato-shi (JP); Yoshihide Matsuda, Chofu-shi (JP); Mamoru Sakai, Kawasaki-shi (JP)

(73) Assignee: SEIKO EPSON CORPORATION, Shinjuku-ku (JP)

(21) Appl. No.: 12/978,245

(22) Filed: Dec. 23, 2010

(30) Foreign Application Priority Data
Dec. 28, 2009 (JP) 2009-297256

(51) Int. Cl. H04W 12/08

(52) U.S. Cl. 380/270

(57) ABSTRACT

A wireless communication apparatus that establishes connection with an access point wirelessly to perform wireless communication is provided. The apparatus includes: a beacon receiving section that receives a beacon that includes identification information of the access point; a key input accepting section that accepts an input of a security key that is to be used for encryption of wireless communication between the wireless communication apparatus and the access point that is a connection target; a communication method determining section that determines, on the basis of the security key, a communication method that is to be used for communication with the access point by selection out of a plurality of communication methods using encryption available for connection with the access point; and a communication controlling section that carries out control for communicating with the access point by using the received identification information of the access point and the determined communication method.

### BACKGROUND

1. Technical Field

The present invention relates to a wireless communication apparatus that establishes connection with an access point wirelessly to perform wireless communication.

2. Related Art

A PC (Personal Computer) that includes a built-in wireless communication unit for establishing connection with an access point connected to a network wirelessly or to which such a wireless communication unit is connected is known as an example of various wireless communication apparatuses. Such a PC is linked to a network such as the Internet via an access point to transmit and receive various kinds of data.

A plurality of communication methods employing, for example, the following encryption schemes in order to provide security for communication between a PC and an access point is known in the art: WEP (Wired Equivalent Privacy), AES (Advanced Encryption Standard), TKIP (Temporal Key Integrity Protocol).

To use such an encrypted communication technique, it is necessary at the PC side to preset the SSID (Service Set ID) of an access point that is to be connected, a communication method that is to be used, and a security key that is to be used for the communication method.

For example, in order to establish connection to a new access point, it is necessary for a user to know the SSID, the communication method, and the security key in advance.

A technique for automatically detecting a wireless network type including an encryption scheme is disclosed in JP-A-2005-176320.

The technique disclosed in JP-A-2005-176320 makes it possible to obtain information on a type in a wireless network. For example, in a case where there is a plurality of access points to which the same SSID is assigned, it is possible to obtain information on a wireless network type for each of the plurality of access points.

However, users have to judge as to which access point should be set as a target of access connection on their own. Therefore, there is a problem in that it is practically difficult for a user who is not familiar with wireless network types to select a right access point as the target of access connection. The problem is not limited to the above specific case. It is not easy for an ordinary user who is not experienced in configuring communication settings to set a communication method for establishing connection with an access point properly.

### SUMMARY

An advantage of some aspects of the invention is to provide a technique for establishing connection with an access point easily and properly.

A wireless communication apparatus according to a first aspect of the invention has the following features. The wireless communication apparatus establishes connection with an access point wirelessly to perform wireless communication. The apparatus includes a beacon receiving section, a key input accepting section, a communication method determining section, and a communication controlling section. The beacon receiving section receives a beacon that includes identification information of the access point. The key input accepting section accepts an input of a security key that is to be used for encryption of wireless communication between the wireless communication apparatus and the access point that is a connection target. The communication method determining section determines, on the basis of the security key, a communication method that is to be used for communication with the access point by selection out of a plurality of communication methods using encryption available for connection with the access point. The communication controlling section carries out control for communicating with the access point by using the received identification information of the access point and the determined communication method. Upon receiving an input of a security key from a user, the wireless communication apparatus can determine, on the basis of the security key, a communication method that is to be used for communication with the access point by selection out of a plurality of communication methods and communicate with the access point by using the determined communication method. Therefore, it is possible to establish connection with the access point easily and properly without any need for the user to know the communication method in advance.

In a wireless communication apparatus according to the first aspect of the invention, it is preferable that the communication method determining section should select, as the communication method that is to be used for communication with the access point, one or more for which a key length of the security key is valid for the encryption out of the plurality of communication methods using encryption available for connection with the access point. The wireless communication apparatus having such a preferred configuration makes it possible to determine candidates of communication methods on the basis of the key length of the security key.

In such a wireless communication apparatus, the communication method determining section may make a sequential selection as the communication method that is to be used for communication with the access point in accordance with a descending order of security invulnerability. With such a sequential selection based on security invulnerability, it is possible to communicate with the access point speedily in an operating environment in which it is designed to set an access security level as high as possible.

Preferably, a wireless communication apparatus according to the first aspect of the invention should further include a memorizing section that memorizes a communication method that was used for previous successful connection with the access point, wherein the communication method determining section preferentially selects the communication method memorized by the memorizing section as the communication method that is to be used for communication with the access point. With such a preferred configuration, it is possible to communicate with the access point speedily in an operating environment in which security is set at the same level.

Preferably, a wireless communication apparatus according to the first aspect of the invention should further include a communication method accepting section that accepts, from a user, an input for designating the communication method that is to be used for communication with the access point, wherein, if there is a communication method designated by the user, the inputted communication method is used for communication with the access point, whereas, if there is not any communication method designated by the user, the communication method determining section determines the communication method that is to be used for communication with the access point by selection out of the plurality of communication methods using encryption available for connection with the access point on the basis of the security key. With such a preferred configuration, in a case where the user knows the communication method in advance, it is possible to communicate with the access point more speedily by using the designated communication method.

Preferably, a wireless communication apparatus according to the first aspect of the invention should further include an identification information displaying section that displays the identification information of the access point, which is included in the received beacon; and a selection accepting section that accepts, from a user, selection of the identification information of the access point that is the connection target, wherein the communication controlling section carries out control for communicating with the access point by using the selected identification information of the access point. With such a preferred configuration, a user can select the identification information of a desired access point out of the identification information of the displayed access points, thereby communicating with the desired access point easily.

In such a wireless communication apparatus, when the beacon receiving section receives more than one type of beacon with which the same identification information is associated, the identification information displaying section may display the identification information as a single object to be selected. Even in a case where there is a plurality of access points to which the same identification information is assigned, since the identification information is displayed as a single object to be selected, a user is not aware of selection out of the plurality of access points to which the same identification information is assigned. Therefore, it is possible to avoid needless confusion, which is user friendly.

A wireless communication method according to a second aspect of the invention, which is implemented by a wireless communication apparatus that establishes connection with an access point wirelessly to perform wireless communication, has the following features. The wireless communication apparatus includes a beacon receiving section, a key input accepting section, a communication method determining section, and a communication controlling section. The wireless communication method includes: receiving a beacon that includes identification information of the access point by the beacon receiving section; accepting an input of a security key that is to be used for encryption of wireless communication between the wireless communication apparatus and the access point that is a connection target by the key input accepting section; determining, on the basis of the security key, a communication method that is to be used for communication with the access point by selection out of a plurality of communication methods using encryption available for connection with the access point by the communication method determining section; and carrying out control for communicating with the access point by using the received identification information of the access point and the determined communication method by the communication controlling section. With such a wireless communication method, upon receiving an input of a security key from a user, the wireless communication apparatus can determine, on the basis of the security key, a communication method that is to be used for communication with the access point by selection out of a plurality of communication methods and communicate with the access point by using the determined communication method. Therefore, it is possible to communicate with the access point easily and properly without any need for the user to know the communication method in advance.

A wireless communication program according to a third aspect of the invention has the following features. A computer that establishes connection with an access point wirelessly to perform wireless communication runs the wireless communication program. The wireless communication program causes the computer to function as a plurality of sections comprising: a beacon receiving section that receives, at least, a beacon that includes identification information of the access point from surrounding access points; a key input accepting section that accepts an input of a security key that is to be used for encryption of wireless communication between the wireless communication apparatus and the access point that is a connection target; a communication method determining section that determines, on the basis of the security key, a communication method that is to be used for communication with the access point by selection out of a plurality of communication methods using encryption available for connection with the access point; and a communication controlling section that carries out control for communicating with the access point by using the received identification information of the access point and the determined communication method. Upon receiving an input of a security key from a user, the computer running the wireless communication program can determine, on the basis of the security key, a communication method that is to be used for communication with the access point by selection out of a plurality of communication methods and communicate with the access point by using the determined communication method. Therefore, it is possible to communicate with the access point easily and properly without any need for the user to know the communication method in advance.

### BRIEF DESCRIPTION OF THE DRAWINGS

The invention will be described with reference to the accompanying drawings, wherein like numbers reference like elements.

FIG. 1 is a diagram that schematically illustrates an example of the configuration of a network system according to an exemplary embodiment of the invention.

FIG. 2 is a flowchart that schematically illustrates an example of wireless communication processing according to an exemplary embodiment of the invention.

### DESCRIPTION OF EXEMPLARY EMBODIMENTS

With reference to the accompanying drawings, an exemplary embodiment of the present invention will now be explained in detail. Although the specific concept of the invention is described below while explaining an exemplary embodiment thereof, the embodiment is not intended to limit the scope of the invention recited in the appended claims to a specific level; nor is it always necessary to encompass all elements described in the following embodiment and/or a combination of all of the elements as a means for solving the problem identified by the invention.

First of all, a network system according to an exemplary embodiment of the invention is explained.

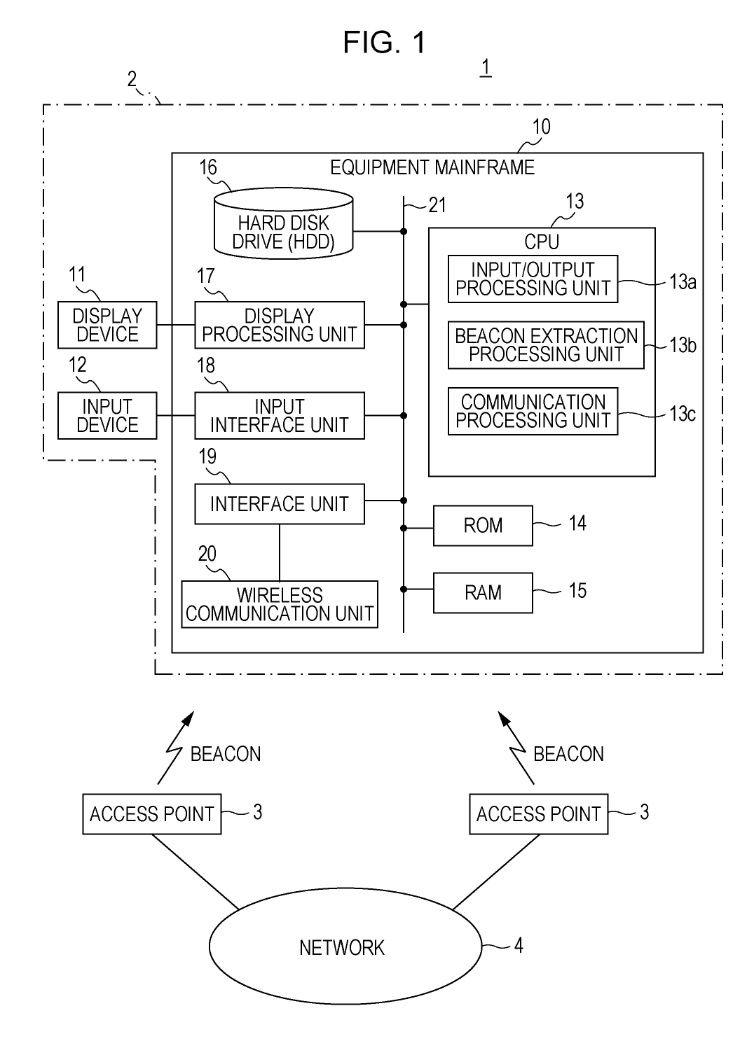

FIG. 1 is a diagram that schematically illustrates an example of the configuration of the network system according to an exemplary embodiment of the invention.

A network system 1 includes wireless communication equipment 2 and at least one access point 3. The access point 3 is connected to a network 4. For example, the access point 3 transmits a beacon at predetermined time intervals. The beacon includes a personal SSID (an example of identification information) of the access point 3. The access point 3 can perform wireless communication by using a communication method in which a preset encryption scheme is employed. Therefore, when the wireless communication equipment 2 communicates with the access point 3, it is necessary to establish connection by a communication method set at the access point 3 with the use of the SSID of the access point 3 and an encryption security key for the set communication method.

An example of the wireless communication equipment 2 is a PC (Personal Computer). The wireless communication equipment 2 includes an equipment mainframe 10, a display device 11, and an input device 12. The display device 11 is a device that displays images, for example, a liquid crystal display, a CRT (Cathode Ray Tube) display, or the like. The input device 12 is a device that enables a user of the wireless communication equipment 2 to input a command or the like. Examples of the input device 12 are a mouse and a keyboard.

In the equipment mainframe 10, a CPU (Central Processing Unit) 13, a ROM (Read Only Memory) 14, a RAM (Random Access Memory) 15, an HDD (Hard Disk Drive) 16, a display processing unit 17, an input interface unit 18, and an interface unit 19 are interconnected via a bus 21.

A basic program such as a boot program is stored in the ROM 14. The RAM 15 is used as a storage area where programs and data are stored and/or a work area where data used for processing by the CPU 13 is stored. Various programs such as an OS (Operating System) program, a communication processing program, and the like are stored readably in the HDD 16.

Under the control of the CPU 13, the display processing unit 17 generates display data or a display signal for displaying an image on the display device 11 and outputs the data or signal to the display device 11. The input interface unit 18 is connected to the input device 12. The input interface unit 18 receives a signal from the input device 12 and sends it as input data to the CPU 13. The interface unit 19 is connected to a wireless communication unit 20, which is an example of a beacon receiving section. The interface unit 19 serves as a data intermediary between the wireless communication unit 20 and the CPU 13.

The wireless communication unit 20 transmits and receives various radio wave signals. In the present embodiment of the invention, the wireless communication unit 20 receives a beacon transmitted from the access point 3 and transfers it to the CPU 13. In a case where, for example, the wireless communication unit 20 receives more than one type of beacon that contains the same SSID but differs in terms of content, that is, beacons coming from a plurality of access points 3 to which the same SSID is assigned, the wireless communication unit 20 transfers each of these beacons to the CPU 13. In addition, the wireless communication unit 20 transmits and receives data by using a communication method in which a designated encryption scheme is employed. Specifically, using a designated access point SSID and a designated security key, the wireless communication unit 20 transmits and receives data by using a communication method in which a designated encryption scheme is employed.

In the present embodiment of the invention, for example, the wireless communication unit 20 can use the following methods for communication, which are mentioned in the descending order of security invulnerability: a communication method in which an AES encryption scheme is employed (most invulnerable), a communication method in which a TKIP encryption scheme is employed, a communication method in which a WEP 128-bit encryption scheme is employed, and a communication method in which a WEP 64-bit encryption scheme is employed (most vulnerable). The length of an AES security key ranges from 8 to 63 characters (ASCII code). The length of a TKIP security key ranges from 8 to 63 characters (ASCII code). The length of a WEP 128-bit security key is equal to 13 characters (ASCII code). The length of a WEP 64-bit security key is equal to 5 characters (ASCII code).

The CPU 13 controls the operation of each of the components 14 to 20. The CPU 13 reads the basic program, which is stored in the ROM 14, the OS program and the wireless communication program, which are stored in the HDD 16, and the like. These programs are read into the RAM 15. By executing these programs, the CPU 13 performs various kinds of processing.

The CPU 13 includes an input/output processing unit 13a, a beacon extraction processing unit 13b, and a communication processing unit 13c. The input/output processing unit 13a is an example of an identification information displaying section, a selection accepting section, and a key input accepting section. The communication processing unit 13c is an example of a communication method determining section and a communication controlling section. The input/output processing unit 13a, the beacon extraction processing unit 13b, and the communication processing unit 13c are components built up by, mainly, executing the wireless communication program by the CPU 13.

The input/output processing unit 13a causes the display device 11 to display the SSID of the access point 3, which is notified from the beacon extraction processing unit 13b, via the display processing unit 17. When a plurality of SSIDs different from one another is received, the input/output processing unit 13a causes the display device 11 to display the plurality of SSIDs. When the same SSID (sent from a plurality of access points 3 to which the same SSID is assigned) is received, the input/output processing unit 13a causes the display device 11 to display it as a single SSID. In addition, the input/output processing unit 13a accepts, via the input device 12 and the input interface unit 18, a user input for selecting one SSID out of the SSIDs displayed on the display device 11, wherein the one SSID indicates an access point 3 that is to be connected with the wireless communication equipment 2. The input/output processing unit 13a sends the input for SSID selection to the communication processing unit 13c. Moreover, the input/output processing unit 13a accepts, via the input device 12 and the input interface unit 18, a user input for designating a security key that is to be used for encrypting a string for connection with the access point 3. The input/output processing unit 13a sends the input for key designation to the communication processing unit 13c.

The beacon extraction processing unit 13b receives the beacon transferred from the wireless communication unit 20, extracts the SSID of the access point 3 from the beacon, and sends the extracted SSID to the input/output processing unit 13a.

On the basis of the security key received from the input/output processing unit 13a, the communication processing unit 13c determines a communication method that is to be used for communication with the designated access point 3 by selecting it out of a plurality of communication methods in each of which an encryption scheme available for connection with the designated access point 3 is employed. In the present embodiment of the invention, the communication processing unit 13c determines a communication method that uses encryption that is valid on the basis of the length of the security key. For example, if the length of the security key is equal to five characters, the communication processing unit 13c determines that a communication method in which a WEP 64-bit encryption scheme is employed is to be used. If, for example, the length of the security key ranges from 8 to 63 characters, the communication processing unit 13c determines that a communication method in which an AES encryption scheme, a TKIP encryption scheme, or a WEP 128-bit encryption scheme is employed is to be used.

Then, the communication processing unit 13c controls the wireless communication unit 20 for attempting to establish connection with the access point 3 by the determined communication method with the use of the received SSID and the received security key. If there is more than one communication method determined, and further if an attempt to establish connection with the access point 3 by a certain communication method, which is one of them, has failed, the communication processing unit 13c controls the wireless communication unit 20 for attempting to establish connection with the access point 3 by another of them.

If an attempt to establish connection with the access point 3 by a certain communication method is successful, the SSID, the security key, and the communication method used for the successful connection is used when communicating with the access point 3 via the wireless communication unit 20 under the control of the communication processing unit 13c.

Next, the operation of wireless communication performed by wireless communication equipment according to an exemplary embodiment of the invention will now be explained.

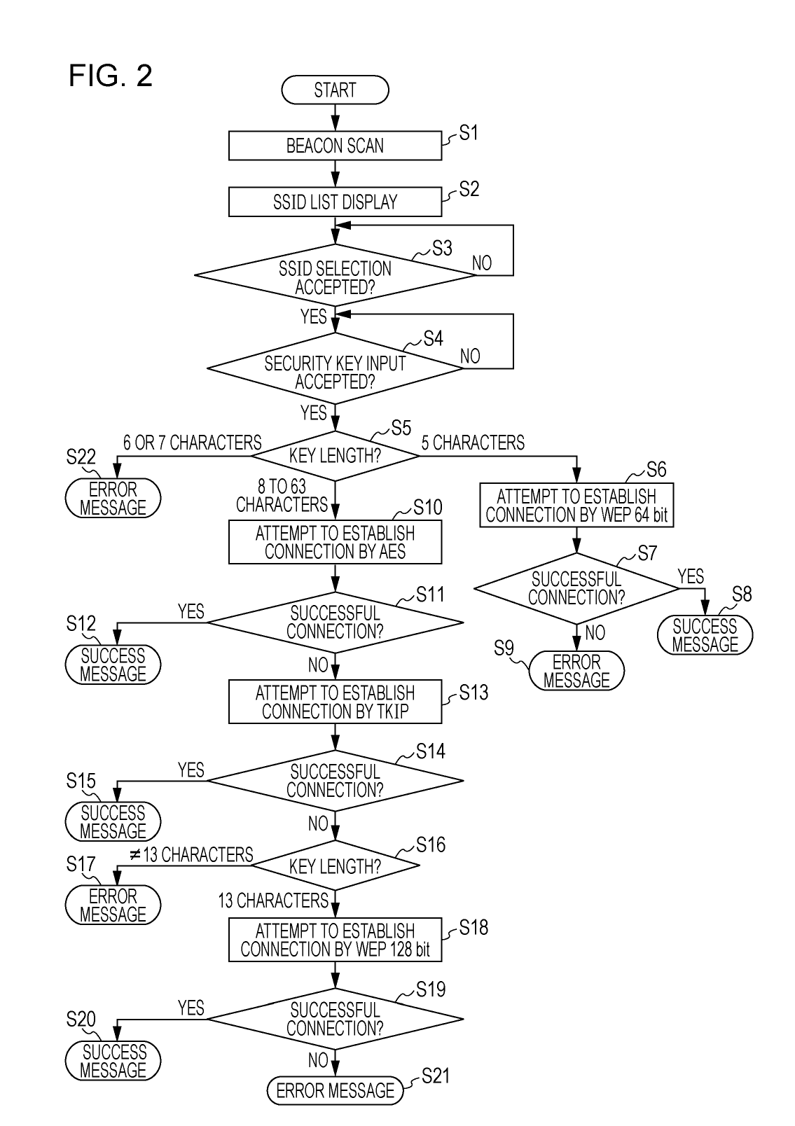

FIG. 2 is a flowchart that schematically illustrates an example of wireless communication processing according to an exemplary embodiment of the invention.

The wireless communication unit 20 receives beacons transmitted from surrounding access points 3 (step S1). The wireless communication unit 20 transfers the beacon to the beacon extraction processing unit 13b. The beacon extraction processing unit 13b extracts the SSID of the access point 3 from the beacon and sends the extracted SSID to the input/output processing unit 13a.

The input/output processing unit 13a causes the display device 11 to display a list of the received SSIDs via the display processing unit 17 for selection among them (step S2). Next, the input/output processing unit 13a judges whether the selection of an SSID by the user has been accepted via the input device 12 or not (step S3). If not (step S3: NO), the judgment is repeated until an SSID is selected. If it is judged that the selection of an SSID has been accepted (step S3: YES), the input/output processing unit 13a sends the SSID to the communication processing unit 13c. Then, the input/output processing unit 13a judges whether a user input of a security key has been accepted via the input device 12 or not (step S4).

If an input of a security key has not been accepted yet (step S4: NO), the input/output processing unit 13a repeats the judgment until a security key is inputted. If it is judged that an input of a security key has been accepted (step S4: YES), the security key is sent to the communication processing unit 13c.

The communication processing unit 13c checks the length of the security key sent from the input/output processing unit 13a (step S5). If the length of the security key is equal to five characters (step S5: 5 char.), it can be determined that a communication method in which a WEP 64-bit encryption scheme is employed is to be used. In such a case, the communication processing unit 13c controls the wireless communication unit 20 for attempting to establish connection with the access point 3 by the WEP 64-bit encryption communication method with the use of the received SSID and the received security key (step S6).

Next, the communication processing unit 13c judges whether the attempted connection with the access point 3 is successful or not (step S7). If connected successfully, under the control of the communication processing unit 13c, the input/output processing unit 13a causes the display device 11 to display a message to the effect that the attempted connection is successful (step S8). In such a case, the WEP 64-bit encryption communication method with the SSID and the security key is used for communication with the access point 3. If not connected successfully, under the control of the communication processing unit 13c, the input/output processing unit 13a causes the display device 11 to display an error message, that is, a message to the effect that the attempted connection is not successful (step S9).

If the length of the security key ranges from 8 to 63 characters (step S5: 8-63 char.), it can be determined that a communication method in which an AES encryption scheme, a TKIP encryption scheme, or a WEP 128-bit encryption scheme is employed is to be used. In such a case, the communication processing unit 13c carries out control for sequentially attempting to establish connection with the access point 3 by, at each attempt, a communication method selected out of them in accordance with the descending order of security invulnerability.

Specifically, as a first step of such sequential attempts, the communication processing unit 13c controls the wireless communication unit 20 for attempting to establish connection with the access point 3 by the AES encryption communication method with the use of the received SSID and the received security key (step S10). Next, the communication processing unit 13c judges whether the attempted connection with the access point 3 is successful or not (step S11). If connected successfully, under the control of the communication processing unit 13c, the input/output processing unit 13a causes the display device 11 to display a message to the effect that the attempted connection is successful (step S12). In such a case, the AES encryption communication method with the SSID and the security key is used for communication with the access point 3.

If not connected successfully (step S11: NO), the communication processing unit 13c controls the wireless communication unit 20 for attempting to establish connection with the access point 3 by the TKIP encryption communication method with the use of the received SSID and the received security key (step S13). Next, the communication processing unit 13c judges whether the attempted connection with the access point 3 is successful or not (step S14). If connected successfully, under the control of the communication processing unit 13c, the input/output processing unit 13a causes the display device 11 to display a message to the effect that the attempted connection is successful (step S15). In such a case, the TKIP encryption communication method with the SSID and the security key is used for communication with the access point 3.

If not connected successfully (step S14: NO), the communication processing unit 13c judges whether the length of the security key is equal to 13 characters or not (step S16). If the key length is not equal to 13 characters (step S16:≠13 char.), the security key is not valid for the remaining one of these three communication methods, that is, the WEP 128-bit encryption communication method. Therefore, in such a case, under the control of the communication processing unit 13c, the input/output processing unit 13a causes the display device 11 to display a message to the effect that the attempted connection is not successful (step S17).

If the key length is equal to 13 characters (step S16: 13 char.), the communication processing unit 13c controls the wireless communication unit 20 for attempting to establish connection with the access point 3 by the WEP 128-bit encryption communication method with the use of the received SSID and the received security key (step S18).

Next, the communication processing unit 13c judges whether the attempted connection with the access point 3 is successful or not (step S19). If connected successfully, under the control of the communication processing unit 13c, the input/output processing unit 13a causes the display device 11 to display a message to the effect that the attempted connection is successful (step S20). In such a case, the WEP 128-bit encryption communication method with the SSID and the security key is used for communication with the access point 3. If not connected successfully, under the control of the communication processing unit 13c, the input/output processing unit 13a causes the display device 11 to display a message to the effect that the attempted connection is not successful (step S21). If the key length is equal to either six characters or seven characters (step S5: 6 or 7 char.), the security key is not valid one for encryption of any of the communication methods that can be used at the wireless communication unit 20. Therefore, in such a case, under the control of the communication processing unit 13c, the input/output processing unit 13a causes the display device 11 to display a message to the effect that the security key is an erroneous key (step S22).

As described above, the present embodiment of the invention makes it possible to establish connection with the access point 3 easily and properly by inputting, by a user, a security key that is to be used without any need to designate a communication method.

Although the invention is explained above on the basis of an exemplary embodiment, the scope of the invention is not limited to the embodiment. The invention can be applied to or embodied in various modes.

For example, in the foregoing embodiment of the invention, it is explained that sequential attempts to establish connection with the access point 3 are made by selecting, at each attempt, a communication method out of a plurality of communication methods in accordance with a predetermined sequential order. However, the scope of the invention is not limited to such an example. For example, the foregoing embodiment may be modified as follows. Information on a communication method that was used for previous communication with the access point 3 (i.e., successful connection with the access point 3) is memorized in the HDD 16, which is an example of a memorizing section. On the basis of the information stored in the HDD 16, the communication processing unit 13c carries out control for using the previous communication method preferentially for attempting to establish connection with the access point 3. For example, the preceding communication method, which was used immediately before the current sequence of attempts, may be selected for the first attempt.

The foregoing embodiment may be modified as follows. The input/output processing unit 13a, which functions as an example of a communication method accepting section, accepts a user input for designating an encryption communication method that is to be used for establishing connection with the access point 3 via the input device 12. If there is an encryption communication method designated by the user, the designated encryption communication method is used for establishing connection with the access point 3. If there is not any encryption communication method designated by the user, connection with the access point 3 may be established in accordance with the step S5 and the subsequent steps illustrated in FIG. 2.

The wireless communication unit 20 may perform at least a part of processing performed by the CPU 13.

In the foregoing embodiment of the invention, it is explained that characters for a security key are inputted as ASCII code. However, the scope of the invention is not limited to such an example. For example, a hexadecimal digit sequence may be inputted.

In the foregoing embodiment of the invention, a PC is taken as an example of a wireless communication apparatus. However, the wireless communication apparatus is not limited to a PC. It may be embodied as any kind of a wireless communication device that can communicate with an access point by radio, for example, a printer, a projector, a game console, or a handheld gaming device.

The entire disclosure of Japanese Patent Application No. 2009-297256, filed Dec. 28, 2009 is expressly incorporated by reference herein.

What is claimed is:

1. A wireless communication apparatus that establishes connection with an access point wirelessly to perform wireless communication, the apparatus comprising:
a beacon receiving section that receives a beacon that includes identification information of the access point;
a key input accepting section that accepts an input of a security key that is to be used for encryption of wireless communication between the wireless communication apparatus and the access point that is a connection target;
a communication method determining section that determines, on the basis of the security key, a communication method that is to be used for communication with the access point by selection out of a plurality of communication methods using encryption available for connection with the access point; and
a communication controlling section that carries out control for communicating with the access point by using the received identification information of the access point and the determined communication method.

2. The wireless communication apparatus according to claim 1, wherein the communication method determining section selects, as the communication method that is to be used for communication with the access point, one or more for which a key length of the security key is valid for the encryption out of the plurality of communication methods using encryption available for connection with the access point.

3. The wireless communication apparatus according to claim 1, wherein the communication method determining section makes a sequential selection as the communication method that is to be used for communication with the access point in accordance with a descending order of security invulnerability.

4. The wireless communication apparatus according to claim 1, further comprising
a memorizing section that memorizes a communication method that was used for previous successful connection with the access point,
wherein the communication method determining section preferentially selects the communication method memorized by the memorizing section as the communication method that is to be used for communication with the access point.

5. The wireless communication apparatus according to claim 1, further comprising
a communication method accepting section that accepts, from a user, an input for designating the communication method that is to be used for communication with the access point,
wherein, if there is a communication method designated by the user, the inputted communication method is used for communication with the access point, whereas, if there is not any communication method designated by the user, the communication method determining section determines the communication method that is to be used for communication with the access point by selection out of the plurality of communication methods using encryption available for connection with the access point on the basis of the security key.

6. The wireless communication apparatus according to claim 1, further comprising
an identification information displaying section that displays the identification information of the access point, which is included in the received beacon; and
a selection accepting section that accepts, from a user, selection of the identification information of the access point that is the connection target,
wherein the communication controlling section carries out control for communicating with the access point by using the selected identification information of the access point.

7. The wireless communication apparatus according to claim 6, wherein, when the beacon receiving section receives more than one type of beacon with which the same identification information is associated, the identification information displaying section displays the identification information as a single object to be selected.

8. A wireless communication method implemented by a wireless communication apparatus that establishes connection with an access point wirelessly to perform wireless communication, the apparatus including a beacon receiving section, a key input accepting section, a communication method determining section, and a communication controlling section, the method comprising:
receiving a beacon that includes identification information of the access point by the beacon receiving section;
accepting an input of a security key that is to be used for encryption of wireless communication between the wireless communication apparatus and the access point that is a connection target by the key input accepting section;
determining, on the basis of the security key, a communication method that is to be used for communication with the access point by selection out of a plurality of communication methods using encryption available for connection with the access point by the communication method determining section; and
carrying out control for communicating with the access point by using the received identification information of the access point and the determined communication method by the communication controlling section.

9. A wireless communication program that is run by a computer that establishes connection with an access point wirelessly to perform wireless communication, the wireless communication program causing the computer to function as a plurality of sections comprising:
a beacon receiving section that receives, at least, a beacon that includes identification information of the access point from surrounding access points;
a key input accepting section that accepts an input of a security key that is to be used for encryption of wireless communication between the wireless communication apparatus and the access point that is a connection target;
a communication method determining section that determines, on the basis of the security key, a communication method that is to be used for communication with the access point by selection out of a plurality of communication methods using encryption available for connection with the access point; and
a communication controlling section that carries out control for communicating with the access point by using the received identification information of the access point and the determined communication method.
